(19) United States
(12) Patent Application Publication
(10) Pub. No.: US 2025/0129922 A1
(43) Pub. Date: Apr. 24, 2025

(54) FOLDABLE LIGHT FIXTURE

(71) Applicant: HGCI, Inc., Marysville, OH (US)

(72) Inventors: Thomas O'Connor, Pasadena, CA (US); Brandon Burkhart, Stuart, FL (US)

(21) Appl. No.: 18/685,622

(22) PCT Filed: Aug. 22, 2022
(86) PCT No.: PCT/US2022/075290

§ 371 Date: Feb. 22, 2024

Related U.S. Application Data
(60) Provisional application No. 63/236,070, filed on Aug. 23, 2021.

(51) Int. Cl. F21V 21/30; F21V 23/00; F21V 23/06

(52) U.S. Cl. CPC F21V 21/30; F21V 23/002; F21V 23/06

(57) ABSTRACT

A foldable light fixture includes a main portion having a control element and a wing portion having a lighting element. The foldable light fixture further includes a hinge feature coupled with the main portion and wing portion and configured to permit movement of the wing portion relative to the main portion between a folded configuration and an unfolded configuration. The hinge feature may be configured to maintain an electrical coupling between the control element and the lighting element in the folded configuration and the unfolded configuration.

### CROSS REFERENCE TO RELATED APPLICATIONS

This application claims the benefit of priority to U.S. Provisional Patent Application No. 63/236,070, filed Aug. 23, 2021, and entitled “FOLDABLE LIGHT FIXTURE”, the disclosure of which is incorporated herewith in its entirety and for all purposes.

### FIELD

The described examples relate generally to light fixtures.

### BACKGROUND

Light fixtures, especially those for horticulture or other growing applications, may have an elongated shape that helps to ensure a large spectral coverage, e.g., help provide light to a larger plan canopy. However, such large or elongated shapes can hinder the ability of a seller, buyer, or other party, to transport and/or store the light fixture. For example, a light bar, a light tube, or other feature may have a length that limits the ability of the light fixture to be packaged and shipped in an economical manner. While light fixtures may be transported in a disassembled state, this requires a customer or a receiver of the light fixture to assemble the light fixture, which may not be desirable by the customer or may result in the light not operating properly (e.g., such as due to an incorrect installation). Assembly of a light fixture from multiple separate pieces may further increase system complexity and contribute to improper or incomplete assemblies. For example, light fixtures may further require electrical connections across different components, which may impair end-user assembly and lead to light fixtures that do not operate as desired. As such, there is a need for systems and techniques that reduce light fixture size while facilitating or streamline electrical couplings between components of the light fixture.

### SUMMARY

Examples of the present disclosure are directed to a foldable light fixture and associated hinge features.

In one example, a foldable light fixture is disclosed. The foldable light fixture includes a main portion. The main portion includes a control element. The foldable light fixture further includes a wing portion. The wing portion includes a lighting element. The foldable light fixture further includes a hinge feature coupled with the main portion and wing portion and configured to permit movement of the wing portion relative to the main portion between a folded configuration and an unfolded configuration. The hinge feature may be configured to maintain an electrical coupling between the control element and the lighting element in the folded configuration and the unfolded configuration.

In another example, the hinge feature may define an electrical connector pathway that is configured to receive an electrical connector extending therethrough and between the main portion the and wing portion. The electrical connector may electrically couple the control element and lighting element. In some cases, the hinge feature may include a first hinge portion and a second hinge portion pivotally coupled with one another about a pivot axis. The first hinge portion may define a first passage configured to receive a first run of the electrical connector. The second hinge portion may define a second passage configured to receive a second run of an electrical connector. In this regard, the first and second passages may cooperate to define the electrical connector pathway.

In another example, movement of the wing portion relative to the main portion between the folded configuration and the unfolded configuration includes a pivoting movement about the pivot axis as defined by the pivotal coupling of the first and second hinge portions. In this regard, the hinge feature may be configured to retain the electrical coupling in the first and second passages during the pivoting movement of the wing portion such that the electrical coupling between the control element and the lighting element is retained.

In another example, the main portion may include an elongated main portion frame component coupled with the hinge feature. The wing portion may include an elongated wing portion frame component coupled with the hinge feature opposite the elongated main portion frame component. In this regard, in the unfolded configuration, the elongated main portion frame component and the elongated wing portion frame component may be arranged along a common direction and at a common elevation. Further, in the folded configuration, the elongated wing portion frame component may be arranged along the common direction and elevationally offset from the elongated main portion frame component. In some cases, in the folded configuration, the elongated wing portion frame component rests on the elongated main portion frame component.

In another example, the main portion may include a hub including the control element. The main portion may further include at least a first and a second elongated main portion frame components. Each of the first and second elongated main portion frame component may extend from a common side of the hub. Further, the wing portion may include at least a first and a second elongated wing portion frame components. The wing portion may further include at least a light feature extending between the first elongated wing portion frame component and the second elongated wing portion frame component. The light feature may include the lighting element. The hinge feature may be one of a pair of hinge features. A first hinge feature of the pair of hinge features may be coupled with the first elongated main portion frame component and the first elongated wing portion frame component. Further, a second hinge feature of the pair of hinge features may be coupled with the second elongated main portion frame component and the second elongated wing portion frame component.

In another example, each of the first hinge feature and the second hinge feature may be configured to maintain an electrical coupling between the control element and the lighting element in the folded configuration and the unfolded configuration.

In another example, a foldable light fixture is disclosed. The foldable light fixture may include a main portion. The foldable light fixture may further include a wing portion. The foldable light fixture may further include a hinge feature coupled with the main portion and wing portion and configured to permit movement of the wing portion relative to the main portion between an unfolded configuration and a folded configuration. The hinge feature may define an electrical connector pathway therethrough. The foldable light fixture may further include an electrical connector extending through the electrical connector pathway and electrically coupling the main portion and the wing portion.

In another example, the hinge feature may be configured to permit a pivoting movement of the wing portion relative to the main portion about a pivot axis along range of motion up to 180 degrees. In this regard, in the folded configuration, the hinge feature may be configured to bend the electrical connector about the pivot axis.

In another example, the hinge feature may include a first hinge portion and a second hinge portion pivotally coupled with one another and cooperating the define the electrical connector pathway. In some cases, each of the first and the second hinge portions have a body portion define a passage. The electrical connector may extend through each of the passages of respect body portions of the first and second hinge portions. Further, each of the first and second hinge portions may include a joint feature extending from the respective body portion of the first and second hinge portion and pivotally coupled with one another on a pivot axis. In this regard, in the unfolded configuration, the electrical connector may extend through the respective passages along the electrical connector pathway and substantially transverse to the pivot axis.

In another example, the main portion includes a main portion light feature. Further, the wing portion may include a wing portion light feature. Accordingly, the electrical connector may be configured to support an electrical coupling of the main portion light feature and the wing portion light feature.

In another example, a hinge feature for a foldable light fixture is disclosed. The first hinge portion includes a first portion body defining a first passage. The first hinge portion further includes a first portion joint feature extending from the first portion body. The hinge feature further includes a second hinge portion. The second hinge portion includes a second portion body defining a second passage. The second hinge portion further includes a second portion joint feature extending from the second portion body. The first portion joint feature and the second portion joint feature may be pivotally coupled with one another on a pivot axis of the hinge feature. Further, the first passage and the second passage may cooperate to define an electrical connector pathway through the hinge feature that is configured to receive an electrical connector extending therethrough. The hinge feature may be configured to maintain the electrical connector in the electrical connector pathway during a pivoting movement of the first and second joint features about the pivoting axis.

In another example, the first hinge portion may include a set of tube mates protruding from the first portion body opposite the first portion joint feature and configured for engagement with a frame component of the light fixture.

In another example, the first portion body may define a protruding ledge adjacent the first portion joint feature. The protruding ledge may be configured to define a landing for the second portion joint feature such that the second portion joint feature is pivotally coupleable with the first portion joint feature.

In another example, the first portion body may define a face configured to establish a stop position for the second portion body about the pivot axis.

In addition to the exemplary aspects and embodiments described above, further aspects and embodiments will become apparent by reference to the drawings and by study of the following description.

### BRIEF DESCRIPTION OF THE DRAWINGS

FIG. 1A depicts a top isometric view of a foldable light fixture in an unfolded configuration.

FIG. 1B depicts a bottom isometric view of the foldable light fixture of FIG. 1A.

FIG. 2 depicts a detail view of the foldable light fixture of FIG. 1A in a transitional configuration.

FIG. 3A depicts a top isometric view of the foldable light fixture of FIG. 1A in a folded configuration.

FIG. 3B depicts a bottom isometric view of the foldable light fixture of FIG. 3A.

FIG. 4 depicts detail 4-4 of FIG. 1A including a hinge feature of the foldable light fixture of FIG. 1A.

FIG. 5A depicts an exploded view of the hinge feature of FIG. 4.

FIG. 5B depicts another exploded view of the hinge feature of FIG. 4.

FIG. 6A depicts an exploded view first hinge portion and the second hinge portion of the hinge feature of FIG. 4.

FIG. 6B depicts another exploded view of the first hinge portion and the second hinge portion of FIG. 6A.

FIG. 7A depicts the hinge feature of FIG. 4 in an unfolded configuration with an electrical connector extending therethrough.

FIG. 7B depicts the hinge feature of FIG. 4 in a folded configuration with the electrical connector of FIG. 7A extending therethrough and bent about a pivot axis of the hinge feature.

FIG. 8A depicts a partial cutaway view of the foldable light fixture of FIG. 1A.

FIG. 8B depicts detail 8A-8A of FIG. 8A including an electrical connector pathway through the hinge feature.

### DETAILED DESCRIPTION

The description that follows includes sample systems, methods, and apparatuses that embody various elements of the present disclosure. However, it should be understood that the described disclosure may be practiced in a variety of forms in addition to those described herein.

The following disclosure relates generally to foldable light fixtures and associated hinge features that facilitate an electrical coupling between two foldable components of the light fixture. In many instances, the light fixture may be used as a horticultural or “grow” light and be configured to have an expanded light emitting area, such as to allow light to penetrate across a large plant canopy. The light fixture examples described herein may have an elongated shape, which may be defined, for example, by certain light bars, light tubs, light emitting diodes (LEDs), or other light emitting features. Often a light fixture has an elongated shape in order to illuminate a desired object or environment, such as a work bench, a dining room table, a grow table or other horticulture-type environment. In some cases, many light fixtures are connected with one another to define a larger light emitting region.

The foldable light fixture and associated hinge features described herein permit the light fixture to fold or move or otherwise transition between a folded configuration and an unfolded configuration, which helps to increase portability and storage capabilities, as well as allow the light fixture to be transported in an assembled or mostly assembled state, making it easier for the end user to install and operate. The hinge feature may broadly permit movement between two portions of the light fixture optionally while maintaining an electrical coupling between the two portions. For example, the hinge feature may define an electrical connector pathway or channel configured to receive an electrical connector, such as a wire, that runs between the portions of the fixtures. The hinge feature may mechanically permit relative moment of the portions between an unfolded configuration and a folded configuration while also holding the electrical connector in the pathway in both configurations, as well as in transition between each configuration. In this manner, the hinge feature may allow the light fixture to be shipped in a folded configuration, with the folded portions electrically coupled to one another, and readily transitioned to an unfolded, operational configuration with portions unfolded and still electrically coupled. This structure and technique may reduce the space required for packaging and shipment while also simplifying installation and enhancing the end user experience.

The hinge feature may include a first hinge portion and a second hinge portion pivotally coupled to one another along a pivot axis. The first hinge portion may include a first body portion that defines a first passage. The second hinge portion may include a second body portion that define a second passage. The first passage and the second passage may cooperate to define an electrical connector pathway through the hinge feature that is configured to receive an electrical connector extending therethrough. The hinge feature is configured to maintain the electrical connector in the electrical connector pathway during a pivoting movement of the first and second joint features about the pivoting axis. For example, an electrical connector, such as a wire, may be received in the first and second passages and retained in the first and second passages as the first and second hinge portions are pivoted relative to one another.

The hinge feature may couple a first portion of the light fixture and a second portion of the light fixture. The first and second portions may be portions of, or define, a frame, a support, a light bar or light fixture, and/or substantially any other portions or component of the light fixture. In an sample implementation, the hinge feature of the present disclosure may be configured to pivotally couple a main portion of the light fixture and a wing portion of the light fixture. The main portion may be a central component of the light fixture including a hub or other structure configured to house a control element (e.g., a switch, dimmer, and so on), component associated with a power source (e.g., a plug), and/or other elements to facilitate the operation of the light fixture. The main portion may also include lighting elements, such as having certain LEDs and/or other lighting elements. The wing or arm portion may be a section of the light fixture that contains one or more lighting elements and that is generally positioned further away from or peripheral to the hub. The lighting elements of the wing portion may be electrically coupled to the lighting elements, control elements and/or other elements of the main portion in order to appropriately operate. The wing portion may extend elongated from or otherwise be arranged end-to-end with the main portion in an unfolded or operational configuration such that light fixture defines the elongated shape. In some embodiments, the lighting features may be defined as cross-beams or other connecting elements that span a distance between two adjacent wing portions, e.g., a first wing portion formed on a first side of the device and coupled to a first side of the hub and a second wing portion formed on a second side of the device and coupled to a second side of the hub.

The hinge feature may be coupled with the main portion and the wing portion such that the wing portion is moveable relative to the main portion. For example, the first portion body of the hinge feature may engage an elongated main portion frame component and the second portion body of the hinge feature may engage an elongated wing portion frame component. The first and second hinge portions may be coupled such that wing portion may move or pivot up to 180 degrees relative to the main portion. This may permit the wing portion to be folded over and rest upon the main portion to define a folded configuration of the foldable light fixture. The wing portion may be subsequently moved or pivoted such that the wing portion is arranged in an unfolded configuration in which the wing portion and the main portion and arranged end-to-end and at a common elevation.

In one example, the light fixture may be shipped in the folded configuration. For example, the wing portion may be pivoted relative to the main portion. This may reduce a three-dimensional footprint of the light fixture, for example, by contracting the length to approximately the length of the main portion. The wing portion may remain electrically coupled to the main portion in the folded configuration, for example, as the hinge feature houses the electrical connector and guides the electrical connector through the respective passages and between the main portion and the wing portion. For example, the electrical connector may be guided through the passage and bent about a pivot axis of the hinge feature. The light fixture may be transitioned to the unfolded configuration may moving the wing portion relative to the main portion. The wing portion may be moved relative to the main portion while the electrical connected extends between the wing portion and the main portion, as guided by the hinge feature.

It will be appreciated that foregoing examples describe a single hinge feature for purposes of illustration. In other cases, and as described herein, the foldable light fixture may include two, three, four, or more hinge features. Further, the light fixture may include at least two hinge features that are configured to pivot about a common pivot axis. Further, the foldable light fixture may include multiple wing portions, such as a first wing portion and a second wing portion, each capable of transitioning between a folded and an unfolded configuration, via the hinge feature, as described herein.

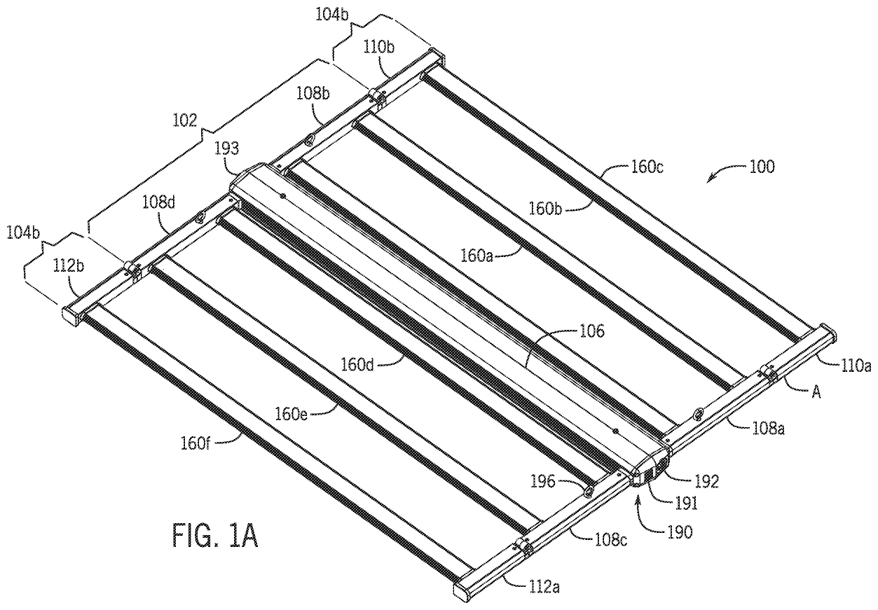

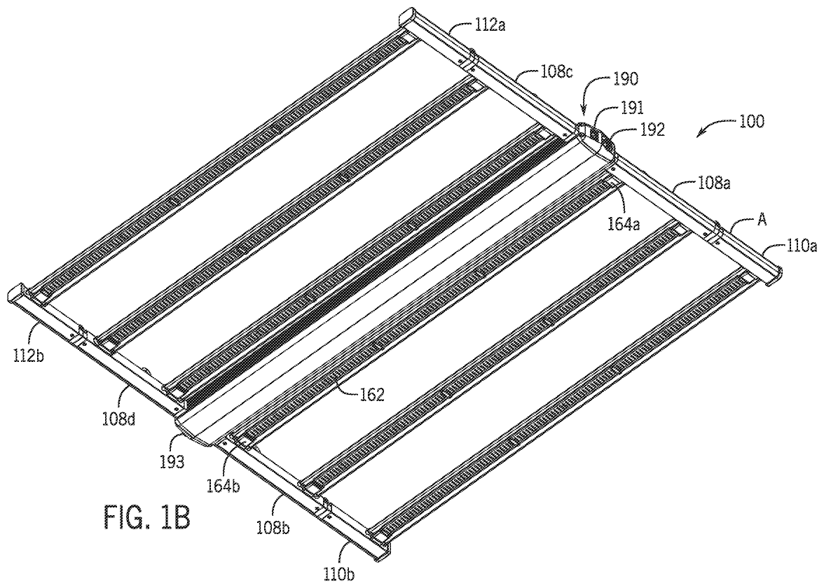

Turning to the drawings, FIG. 1A depicts a foldable light fixture 100, such as the foldable light fixtures discussed generally above and described in greater detail below. The foldable light fixture 100 may include a main portion 102 and one or more wing portions that are moveable or foldable relative to the main portion 102. In the example shown in FIG. 1, the foldable light fixture 100 includes a first wing portion 104a and a second wing portion 104b. The main portion 102 may be a central portion of the foldable light fixture 102 and the first and second wing portions 104a, 104b may be peripheral portions of the foldable light fixture 100 that extend from the main portion 102. The main portion 102 may include a hub 106 or other structure that is configured to house a control element (e.g., a switch, dimmer, and so on), component associated with a power source (e.g., a plug), and/or other elements to facilitate the operation of the light fixture. For example, the main portion 102 is shown with controls 190, including features 191, 192, 193. The feature 191 may be an electrical socket or connector that is configured to allow the foldable light fixture 100 to be connected to a power source, such as a power source or system of a building. The features 192, 193 may include on/off switches, dimmers, and/or other features to facilitate one or more operations of the light fixture 100.

The main portion 102 may also include various lighting elements that are electrically coupled with the hub 106. The first and second wing portions 104a, 104b may also include various lighting elements that are electrically couple with the hub 106 and/or other components of the main portion 102, such as the light elements of the main portion 102. The first and second wing portions 104a, 104b may remain electrically coupled with the respective components of the main portion 102 while being moveable relative to the main portion 102 using the various hinge features described herein.

With reference to the example of FIG. 1A, the foldable light fixture 100 may include one or more light features, for example, a first light feature 160a, a second light feature 160b, a third light feature 160c, a fourth light feature 160d, a fifth light feature 160e, and a sixth light feature 160f. In the present example, each of the light features 160a-160e may be elongated structures that are oriented substantially parallel with one another and may be coupled perpendicularly relative to one or more wing portions. The light features 160a-160e may provide or define structural cross-members that enhance the structural rigidity of the light fixture 100. Further, each of the light features 160a-160e may be offset or separated from one another in the fixture 100. In other examples, more or fewer light features may be used, including more or fewer light features with different orientations. Broadly, a given light feature is a component or section or subassembly of the foldable light fixture 100 that is configured to emit light. As shown in FIG. 1B, the first light feature 160a is shown as including a light strip 162. The light strip 162 may house a plurality of LEDs or other light elements that are configured to emit light from the first light feature 160a. The LEDs may be serially arranged LEDs. In other cases, the light strip 162 may include a single, linear fluorescent tube light. The first light feature 160a, with continued reference to FIG. 1B, is shown with a first end coupling 164a and a second end coupling 164b. The light strip 162 may be electrically coupled in the foldable light fixture 100 via the first and coupling 164a and the second end coupling 164b. This may allow the light strip 162 to be removed and reinstalled or replace as a unit. In other cases, individual LEDs or other lighting elements may be replaceable on the light strip 162.

While many configurations are possible, in the example shown in FIGS. 1A and 1B, the first light feature 160a, the second light feature 160b, the fourth light feature 160d, and the fifth light feature 160e may be associated with or included as components or subassemblies of the main portion 102. Further, the third light feature 160c may be included as a component or subassembly of the first wing portion 104a. As such, the third light feature 160c may be moveable or foldable relative to the first light feature 160a, the second light feature 160b, the fourth light feature 160d, and the fifth light feature 160e using the various hinge features described herein. Further, the sixth light feature 160f may be included as a component or subassembly of the second wing portion 104b. As such, the sixth light feature 160f may be moveable or foldable relative to the first light feature 160a, the second light feature 160b, the fourth light feature 160d, and the fifth light feature 160e using the various hinge features described herein.

The foldable light fixture 100 may include various frames or other structural components to support the light features described herein. For example, and as shown in FIGS. 1A and 1B, the main portion 102 may include a first main portion frame component 108a, a second main portion frame component 108b, a third main portion frame component 108c, and a fourth main portion frame component 108d. The main portion frame components 108a-108d may be tubular or other structures that are capable of structurally supporting multiple light features relative to the hub 106. The main portion frame component 108a-108d may also be configured to carry an electrical connector throughout the foldable light fixture 100, and may therefore be hollow or otherwise include a passage therethrough. In some cases, one or more or all of the main portion frame components 108a-108d may be coupled with eyelets 196 or other features that allow the foldable light fixture 100 to be suspended from a ceiling. As further shown in FIGS. 1A and 1B, the first wing portion 104a may include first wing portion frame components 110a, 110b and the second wing portion 104b may include second wing portion frame components 112a, 112b, each of which may substantially analogous to the main portion frame components 108a-108d described above.

The main portion frame components 108a-108d may be connected to and extend from the hub 106. For example, the first and second main portion frame components 108a, 108b may generally be arranged at a common elevation with one another and extended from a common side of the hub 106, e.g., in the same plane as one another. Further, the third and fourth main portion frame components 108c, 108d may generally be arranged at a common elevation with one another and extend from a common side of the hub 106, generally opposite the first and second main portion frame component 108a, 108b. The first and second light features 160a, 160b may extend between, and be structurally supported in the foldable fixture 100 by, the first and second main portion frame components 108a, 108b. The first and second light features 160a, 160b may therefore define structural cross-members that enhance the structural rigidity of the frame components 108a, 108b. The first and second light features 160a, 160b may run generally parallel with a longitudinal direction of the hub 106 and be electrically coupleable with components of the hub 106 via an electrical connector running through one or both of the first and second frame portion components 108a, 108b. The fourth and fifth light feature 160d, 160e may extend between, and be structurally supported in the foldable light fixture 100 by, the third and fourth main portion frame components 108c, 108d. The fourth and fifth light features 160d, 160e may therefore define structural cross-members that enhance the structural rigidity of the frame components 108c, 108d. The third and fourth light features 160c, 160d may run generally parallel with the longitudinal direction of the hub 106 and be electrically coupleable with components of the hub 106 via an electrical connector running through one or both of the third and fourth frame portion components 108c, 108d.

With reference to the first wing portion 104a, the third light feature 160c may extend between, and be structurally supported in the foldable light fixture 100 by, the first wing portion frame components 110a, 110b. The third light feature 160c may therefore define a structural cross-member that enhances the structural rigidity of the frame components 110a, 110b. The third light feature 160c may run generally parallel with the longitudinal direction of the hub 106 and be electrically coupled with the components of the hub 106, or main portion 102 more generally, via an electrical connector running through one or both of the first wing portion frame components 110a, 110b. With reference to the second wing portion 104b, the sixth light feature 160f may extend between, and be structurally supported in the foldable light fixture 100 by, the second wing portion frame components 112a, 112b. The six light feature 160f may therefore define a structural cross-member that enhances the structural rigidity of the frame components 112a, 112b. The sixth light feature 160f may run generally parallel with the longitudinal direction of the hub 106 and be electrically coupled with the components of the hub 106, or main portion 102 more generally, via an electrical connector running through one or both of the second wing portion frame components 112a, 112b.

The foldable light fixture 100 may also include one more hinge features 130. Broadly, the hinge features 130 may permit movement or folding of the wing portions 104a, 104b relative to the main portion 102. The hinge features 130 may permit movement or folding of the wing portions 104a, 104b relative to the main portion 102 while allowing the wing portions 104a, 104b to maintain an electrical coupling with the main portion 102. For example, the hinge feature 130 may include one or more passages that define an electrical pathway for a wire or other electrical connector across a range or positions of the wing portions 104a, 104b relative to the main portion 102.

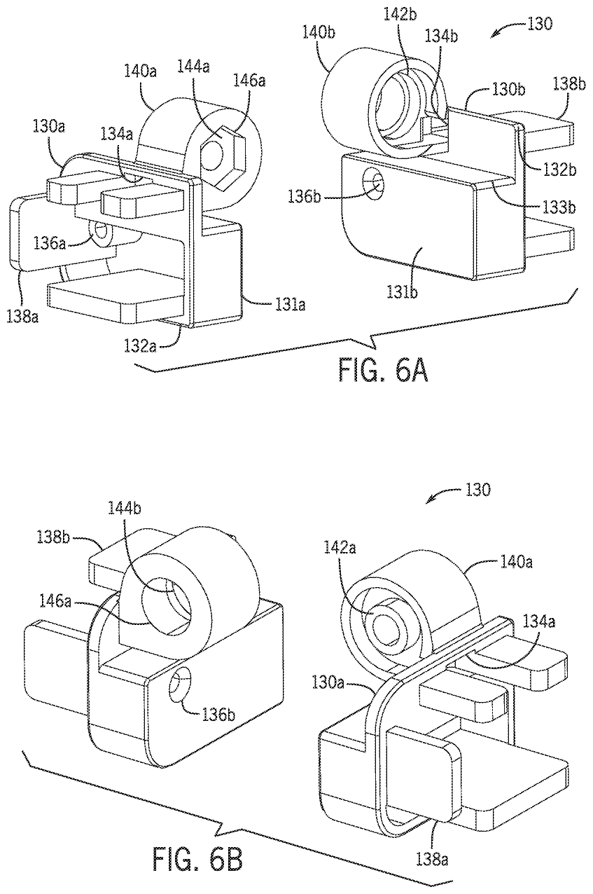

In one example implementation, and as shown with respect to FIGS. 6A and 6B, the hinge feature 130 may include a first hinge portion 130a and a second hinge portion 130b. The first hinge portion 130a may include a first portion body 132a. The first portion body 132a may be an integrally formed or one piece structure that is configured to define a portion of a rotational or a pivot joint that includes a guide of passage for an electrical connector or wire. For example, the first body portion 132a may include first portion joint feature 140a. The first portion joint feature 140a may be a generally cylindrical structure that is configured for engagement about a pivot or rotational axis of the hinge feature 130 and includes a first portion joint feature through portion 144a and a first portion joint feature fastener seat 146a. The first portion joint feature through portion 144a may be a cylindrical hole through the first portion joint feature 140a that is configured to receive a fastener or other device on the pivot axis.

The first body portion 132a is also shown as including a first portion hinge passage 134a. The first portion hinge passage 134a may extend through a complete thickness of the first body portion 132a. The first portion hinge passage 134a may be configured to receive an electrical connector, such as a wire, therethrough. The first portion hinge passage 134a may be configured to define a pathway for the electrical connector through the hinge feature 130, in cooperation with the second hinge portion 130b, that proceeds about the pivot axis. The hinge feature 130 may therefore guide the electrical connector about the pivot axis and permit relative movement of the first and second hinge portions 130a, 130b without substantial impairment or impingement of the electrical connector. The first portion hinge passage 134a may be positioned apart from and proximal to the pivot axis (e.g., as defined by the first portion joint feature through portion 144a) in order to minimize a travel of the electrical connector about the pivot axis.

The first body portion 132a is further shown as including a first portion auxiliary hinge passage 136a. The first portion auxiliary hinge passage 136a may be through portion of the first body portion 132a that is configured to receive a fastener or other feature to facilitate attachment of the first hinge portion 130a to the tubular frames of the foldable light fixture 100. First portion tube mates 138a may also be defined about the first portion joint feature 140a to form a friction or other fit with the frame. For example, the first portion tube mates 138a may be tabs, protrusion, or other like that are placed about a perimeter of the body portion 132a and are at least partially insertable into the frame to establish a friction fit therewith.

With reference to FIGS. 6A and 6B, the first body portion 132a is further shown as defining a first portion face 131a. The first portion face 131a may be a generally planar surface that is arranged opposite the first portion tube mates 138a. The first portion face 131a may define a stop or engagement surface that limits relative movement of the second hinge portion 130b. The first body portion 132a is further shown as defining a ledge 133a. The ledge 133b may be a generally planar surface that is arranged transverse to the planar surface defined by the first portion face 131a. The ledge 133b may define a seat or space for accommodating a component of the second hinge portion along the pivot axis.

With continued reference to FIGS. 6A and 6B, the hinge feature 130 may include the second hinge portion 130b. The second hinge portion 130b may be substantially analogous to the first hinge portion 130a and include: a second portion face 131b, a second portion body 132b, a second portion protruding ledge 133b, a second portion hinge passage 134b, a second portion auxiliary hinge passage 136b, a second portion tube mates 138b, a second portion joint feature 140b, a second portion joint engagement feature 142b, a second portion joint feature through portion 144b, and a second portion joint feature fastener seat 146b, redundant explanation of which is omitted herein for clarity.

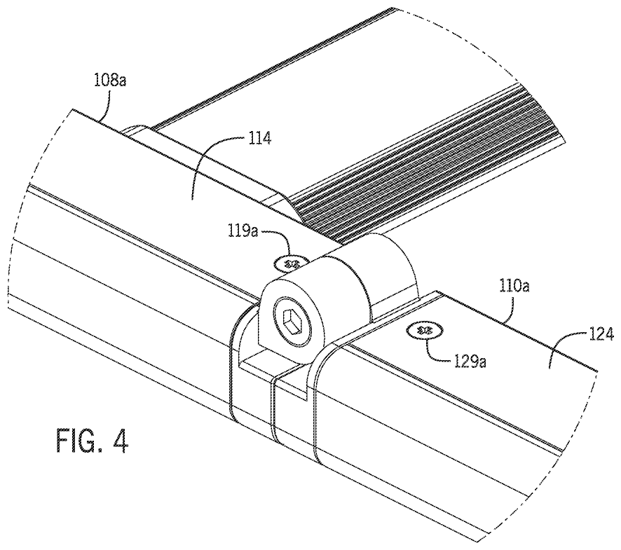

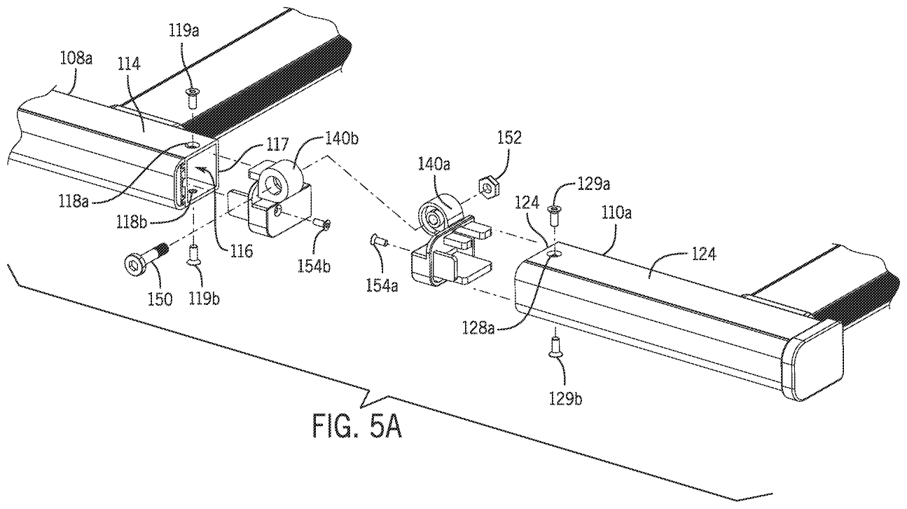

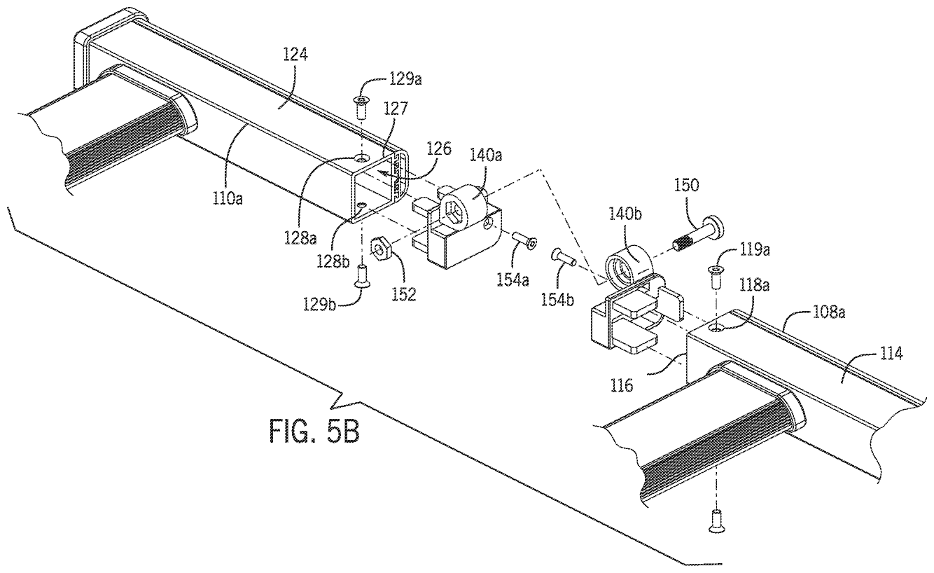

The hinge feature 130 may be coupled by pivotally coupling the first hinge portion 130a and the second hinge portion 130b at a pivot axis. For example, and as shown with reference to FIGS. 4-5B, the first portion joint feature 140a may be partially received or otherwise engaged with the second portion joint feature 140b. The first portion joint feature 140a and the second portion joint feature 140b may be aligned with one another such that the first and second joint feature through portions 144a, 144b are generally concentric along the pivot axis. A fastener 150, such as a bolt, a rod, a screw, and so on, may be advanced through the throughout portions 144a, 144b. An end or head of the fastener 150 may be seated on the first portion joint feature fastener seat 146a. An opposing end of the fastener 150 may be arranged in and protrude from the second portion joint feature fastener seat 146b. A securing component 152, such as a washer, nut, or the like, may be threaded on to the opposing end of the fastener 150 to retain the fastener 150 received by the first and second hinge portions 130a, 130b. The first and second hinge portions 130a, 130b may thus rotate relative to one another about a pivot axis defined by the fastener 150.

With further reference to FIGS. 5A and 5B, the hinge feature 130 may be coupled in the foldable light fixture to permit relative movement of one of the first or second wing portions 104a, 104b and the main portion 102. For example, the first hinge portion 130a may be coupled to the one of the main portion frame components 108a-108d and the second hinge portion 130b may be coupled to one of the wing portion frame components 110a, 110b, 112a, 112b. The one of the wing portion frame components 110a, 110b, 112a, 112b may therefore move or pivot or fold relative to the corresponding one of the main portion frame components 108a-108d, about the pivot axis.

FIGS. 5A and 5B show one example coupling of the hinge feature 130 in the foldable light fixture 100. For example, the second hinge portion 130b may be coupled with a tubular body 114 of the first main portion frame component 108a by at least partially inserting the second portion tube mates 138b through a hinge opening 117 and into a hollow portion 116. In some cases, the second portion tube mates 138b may be configured to engage interior walls of the tubular body 114 at the hollow portion 116 in order to define a friction fit with the first main portion frame component 108a. Once inserted, fasteners 119a, 119b may be advanced through opposing fastener openings 118a, 118b defined through the tubular body 114. The fasteners 119a, 119b may engage the second portion tube mates 138b in order to prevent exit of the second hinge portion 130b from the first main portion frame component 108a. In some cases, a set screw 154b may be advanced through the second portion auxiliary hinge passage 136b in order to further secure the second hinge portion 130b.

As further shown in FIGS. 5A and 5B, the first hinge portion 130a may be coupled with a tubular body 124 of the first wing portion frame component 110a by at least partially inserting the first portion tube mates 138a through a hinge opening 127 and into a hollow portion 126. In some cases, the first portion tube mates 138a may be configured to engage interior walls of the tubular body 124 at the hollow portion 126 in order to define a friction fit with the first wing portion frame component 110a. Once inserted, fasteners 129a, 129b may be advanced through opposing fastener openings 128a, 128b defined through the tubular body 124. The fasteners 129a, 129b may engage the first portion tube mates 138a in order to prevent exit of the first hinge portion 130a from the first wing portion frame component 110a. In some cases, a set screw 154a may be advanced through the first portion auxiliary hinge passage 136a in order to further secure the first hinge portion 130a.

It will be appreciated that multiple hinge features 130 may be used to couple multiple frame components or other sections of the foldable light fixtures. For example, and as shown in FIGS. 1A and 1B, four hinge features are shown. In this regard, the first wing portion 104a may be coupled with the main portion 102 with a set of two hinge features 130. Further, the second wing portion 104b may be coupled with the main portion 102 with another two hinge features 130.

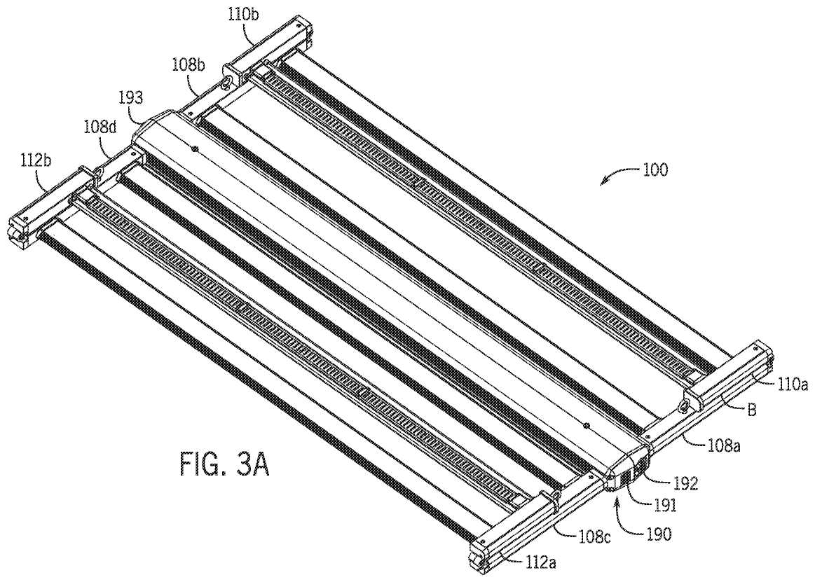

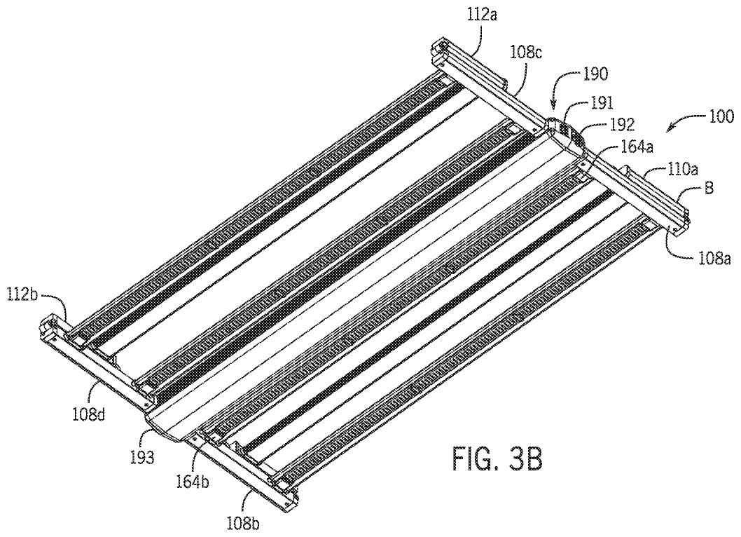

Further, the foldable light fixture 100 may be constructed such that the hinge features 130 are arranged at any appropriate location along a length of the tubular bodies 114, 124. For example, the hinge features 130 may be arranged such that the wing portions 104a, 104b fold or move at least one elongated light feature, as shown in FIG. 1A. In this regard, the wing portions 104a, 104b may be folded into the folded configuration B (FIG. 3A) such that a space or gap is defined between the respective wing portion 104a, 104b and the hub 106. This space may be used for packaging materials, accessories, or the like. In other examples, the hinge features 130 may be arranged such that the wing portions 104a, 104b fold or move additional light features. For example, hinge features 130 may be arranged such that the length of the wing portions 104a, 104b is similar to the length of the abutting frame component. In this regard, the wing portions 104a, 104b would be folded into the folded configuration with a reduced gap between the wing portions and the hub 106, which may help maximize compactness of large light fixtures for shipment. More generally, hinge features 130 may be positioned such that the total folded configuration (e.g., including the length, the width, the area, and/or other dimension) fits within a desired range. Additionally or alternatively, the hinge features 130 may be positioned in order to increase strength or rigidity of the light fixture 100, such as being positioned at or near a crossbar location (e.g., light feature locations) as well as to help ensure that the pockets or spaces between the crossbars and the crossbars or other perpendicular aligned elements to the wings, such as the lighting features, align with one another in the folded configuration.

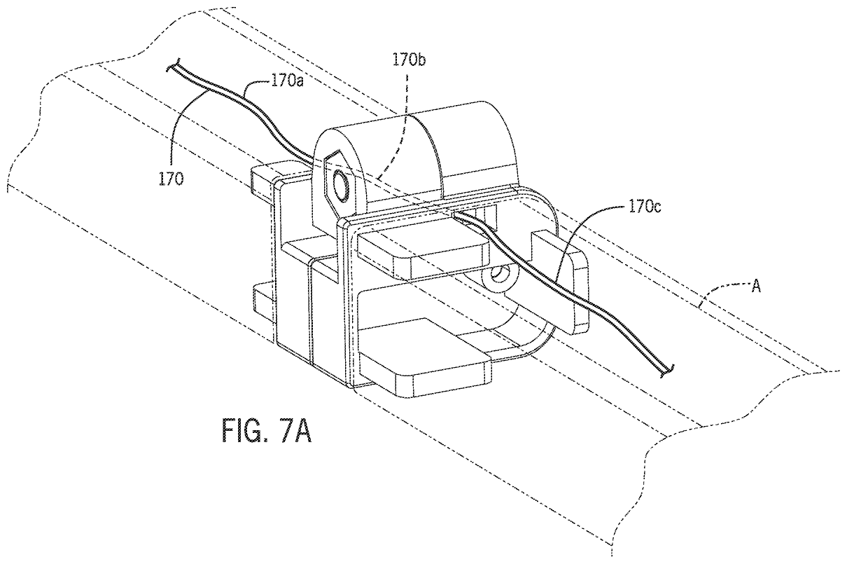

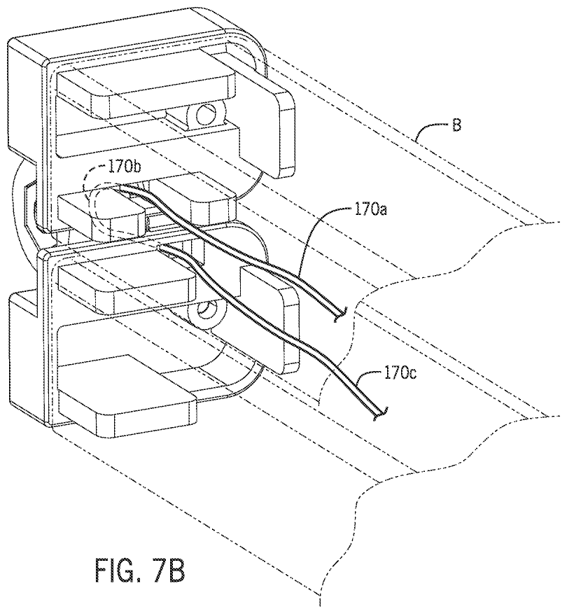

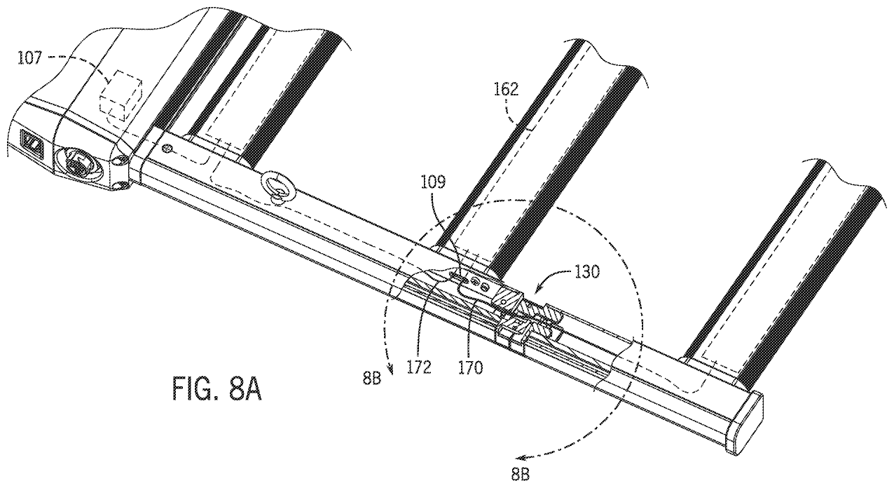

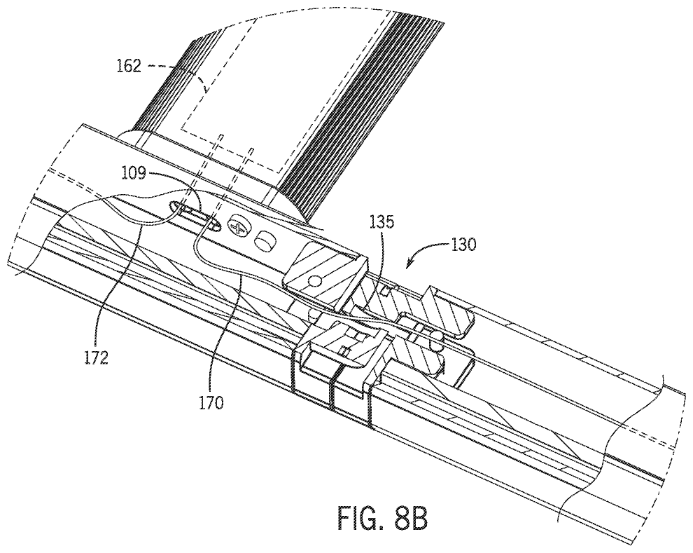

The foldable light fixture 100 may be further coupled with various electrical connectors, such as wires, in order to facilitate one or more operations of the foldable light fixture 100. For example, and as shown in FIGS. 7A-8B, an electrical connector 170 or series or combination of electrical connectors may be disposed within the foldable light fixture 100. Broadly, the electrical connector 170 may operate to electrically connect any two electrical components of the foldable light fixture 100, such as an electrical connection between a control elements, switch, light elements, and the like. As shown in FIG. 8A, a series of electrical connectors 170 may operate to electrically couple a control element 107 of the main portion 102 with one or more light elements, such as the light strip 162.

To facilitate the foregoing, the electrical connector 170 may be arranged within the tubular bodies 114, 124 of the main portion 102 and wing portion 104a frames. For example, the electrical connectors 170 may extend along a length of the frame components and optionally spilt or be routed to the light elements through wire ports 109, as shown in FIGS. 8A and 8B.

The electrical connector 170 may also extend through the hinge feature 130. As shown in FIG. 8B, the first portion hinge passage 134a and the second portion hinge passage 134b may cooperate to define an electrical connector pathway 135. The electrical connector 170 may be received by the first portion hinge passage 134a and the second portion hinge passage 134b and extend through the electrical connector pathway 135. The electrical connector pathway 135, as defined by the hinge feature 130, may allow the hinge feature 130 to maintain an electrical coupling between the main portion 102 and the first or second wing portions 104a, 104b by accommodating the passage of the electrical connector through the hinge feature 130. Such electrical coupling may be maintained during operation of the hinge feature 130 to facilitate relative movement of the first or second wing portions 104a, 104b and the main portion 102.

To illustrate, in operation, the hinge feature 130 may allow the foldable lighting fixture 100 to transition between an unfolded configuration and a folded configuration by permitting movement of the first and second wing portions 104a, 104b relative to the main portion 102. For example, as shown in FIGS. 1A and 1B, the foldable light fixture 100 may be arranged in an unfolded configuration A. In the unfolded configuration A, the first and second wing portions 104a, 104b are arranged extending from opposing sides of the main portion 102. The first and second wing portions 104a, 104b may be arranged extending from opposing sides of the main portion 102 are positioned at a generally common elevation as the main portion 102. For example, in the unfolded configuration A, the first wing portion frame components 110a, 110b may be arranged end-to-end and at a common elevation with the respective ones of the main portion frame component 108. Further, second wing portion frame components 112a, 112b may be arranged end-to-end and at a common elevation with the respective ones of the main portion frame components 108.

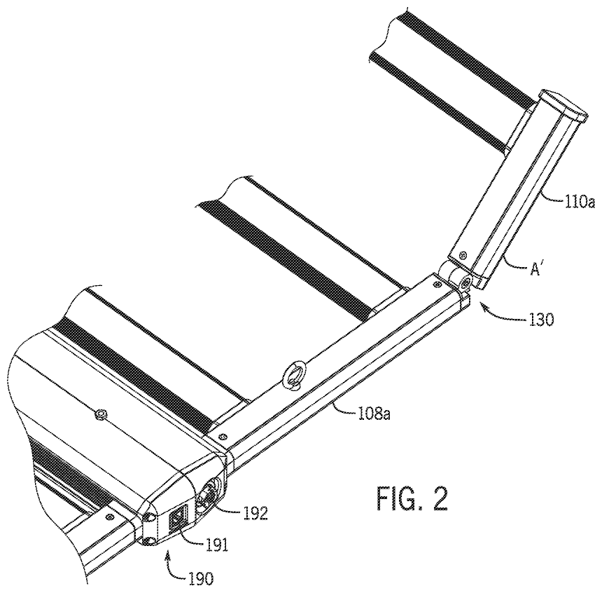

The hinge features 130 may operate to permit the rotation of the respective wing portions 104a, 140b relative to the main portion 102. As shown in FIG. 2, the foldable light fixture 100 may define a transitional state A′ in which the first wing portion 104a is caused to move from the unfolded configuration A. The hinge feature 130 may permit movement of the first or second wing portion 104a, 104b along a range of motion up to 180 degrees.

In this regard, FIGS. 3A and 3B show the foldable light fixture 100 in a folded configuration B. In the folded configuration B, the first wing portion 104a may be rotated relative to the main portion 102 such that the first wing portion 104a rests on or is otherwise folded over the main portion 102. For example, the first wing portion frame components 110a, 110b may be arranged elevationally offset from the respective ones of the main portion frame components 108 and resting thereon. Further, in the folded configuration B, the second wing portion 104b may be rotated relative to the main portion 102 such that the second wing portion 104b rests on or is otherwise folded over the main portion 102. For example, the second wing portion frame components 112a, 112b may be arranged elevationally offset from the respective ones of the main portion frame components 108 and resting thereon.

With reference to FIGS. 7A and 7B, in operation, the hinge feature 130 may permit the main portion 102 and the first or second wing portions 104a, 104b to be electrically coupled with one another in each of the unfolded configuration A, the transitional configuration A′, and the folded configuration B. To illustrate, FIG. 7A shows the foldable light fixture 100 in the unfolded configuration A with the electrical connector 170 having a first run 170a arranged in the tubular body 114, a second run 170b arranged through the electrical connector pathway 135, and a third run 170b arranged in the tubular body 170c. In this manner, the hinge feature 130 may permit the electrical coupling of components of the main portion 102 and the respective wing portions 104a, 104b by defining a passage for the electrical connector 170 to pass therethrough in the unfolded configuration A. As further shown in FIG. 7A, the hinge feature 130 permit passage of the electrical connector 170 through the hinge feature 130 adjacent to, and non-intersecting with, the pivot axis.

The hinge feature 130 is further operational to maintain the electrical coupling of the components of the main portion 102 and the respective wing portions 104a, 104b in the transitional and folded configurations A′, B. To illustrate, FIG. 7B shows the foldable light fixture 100 in the folded configuration B with the electrical connector 170 bent around the pivot axis of the hinge feature 130. For example, the second run 170b of the electrical connector 170 enters the hinge feature 130 at the second portion hinge passage 134b, is guided along the electrical connector pathway 135 around the pivot axis, and exits the hinge feature 130 at the first portion hinge passage 134a. In part because the hinge feature 130 guides the electrical connector about the axis, the hinge feature 130 may mitigate impingement of the electrical connector 170. In this manner, the hinge feature 130 may permit the electrical coupling of components of the main portion 102 and the respective wing portions 104a, 104b by defining a passage for the electrical connector 170 to pass therethrough in the folded configuration B.

In addition to the various functional considerations, the hinge feature 130 may be selected to have an aesthetically pleasing appearance. For example, a shape of the first hinge portion 130a and/or the second hinge portion 130b may be configured to match a profile or outer contour of one or more of the tubular bodies 114, 124. This may allow the coupled hinge feature 130 to form a streamlined design with the tubular bodies 114, 124 that may contribute to the aesthetic appearance of the hinge feature 130. Furthermore, the position and arrangement of the hinge feature 130 within the light fixture 100 may be based, in part, on aesthetic considerations. For example, the hinge feature 130 may be arranged so that the wing portions 104a, 104b may bend or transition in an aesthetically pleasing manner, among other considerations.

Other examples and implementations are within the scope and spirit of the disclosure and appended claims. Thus, the foregoing descriptions of the specific examples described herein are presented for purposes of illustration and description. They are not targeted to be exhaustive or to limit the examples to the precise forms disclosed. It will be apparent to one of ordinary skill in the art that many modifications and variations are possible in view of the above teachings.

What is claimed is:

1. A foldable light fixture comprising:
a main portion comprising a control element;
a wing portion comprising a lighting element; and
a hinge feature coupled with the main portion and wing portion and configured to permit movement of the wing portion relative to the main portion between a folded configuration and an unfolded configuration,
wherein the hinge feature is configured to maintain an electrical coupling between the control element and the lighting element in the folded configuration and the unfolded configuration.

2. The foldable light fixture of claim 1, wherein the hinge feature defines an electrical connector pathway that is configured to receive an electrical connector extending therethrough and between the main portion the and wing portion, the electrical connector electrically coupling the control element and lighting element.

3. The foldable light fixture of claim 2, wherein
the hinge feature comprises a first hinge portion and a second hinge portion pivotally coupled with one another about a pivot axis,
the first hinge portion defines a first passage configured to receive a first run of the electrical connector, and
the second hinge portion defines a second passage configured to receive a second run of an electrical connector, the first and second passages cooperating to define the electrical connector pathway.

4. The foldable light fixture of claim 3, wherein
the movement of the wing portion relative to the main portion between the folded configuration and the unfolded configuration comprises a pivoting movement about the pivot axis as defined by the pivotal coupling of the first and second hinge portions, and
the hinge feature is configured to retain the electrical coupling in the first and second passages during the pivoting movement of the wing portion such that the electrical coupling between the control element and the lighting element is retained.

5. The foldable light fixture of claim 1, wherein
the main portion comprises an elongated main portion frame component coupled with the hinge feature,
the wing portion comprising an elongated wing portion frame component coupled with the hinge feature opposite the elongated main portion frame component, and
in the unfolded configuration, the elongated main portion frame component and the elongated wing portion frame component are arranged along a common direction and at a common elevation.

6. The foldable light fixture of claim 5, wherein, the folded configuration, the elongated wing portion frame component is arranged along the common direction and elevationally offset from the elongated main portion frame component.

7. The foldable light fixture of claim 6, wherein, in the folded configuration the elongated wing portion frame component rests on the elongated main portion frame component.

8. The foldable light fixture of claim 1, wherein
the main portion comprises
a hub comprising the control element, and
at least a first and a second elongated main portion frame component, each extending from a common side of the hub, and
the wing portion comprises
at least a first and a second elongated wing portion frame components, and
at least a light feature extending between the first elongated wing portion frame component and the second elongated wing portion frame component, the light feature comprising the lighting element, and
the hinge feature is one of a pair of hinge features, a first hinge feature of the pair of hinge features coupled with the first elongated main portion frame component and the first elongated wing portion frame component, a second hinge feature of the pair of hinge features coupled with the second elongated main portion frame component and the second elongated wing portion frame component.

9. The foldable light fixture of claim 8, wherein each of the first hinge feature and the second hinge feature are configured to maintain an electrical coupling between the control element and the lighting element in the folded configuration and the unfolded configuration.

10. A foldable light fixture comprising:
a main portion;
a wing portion;
a hinge feature coupled with the main portion and wing portion and configured to permit movement of the wing portion relative to the main portion between an unfolded configuration and a folded configuration, wherein the hinge feature defines an electrical connector pathway therethrough; and
an electrical connector extending through the electrical connector pathway and electrically coupling the main portion and the wing portion.

11. The foldable light fixture of claim 10, wherein the hinge feature is configured to permit a pivoting movement of the wing portion relative to the main portion about a pivot axis along range of motion up to 180 degrees.

12. The foldable light fixture of claim 11, wherein, in the folded configuration the hinge feature is configured to bend the electrical connector about the pivot axis.

13. The foldable light fixture of claim 10, wherein the hinge feature comprises a first hinge portion and a second hinge portion pivotally coupled with one another and cooperating the define the electrical connector pathway.

14. The foldable light fixture of claim 13, wherein
each of the first and the second hinge portions comprise a body portion define a passage, and
the electrical connector extends through each of the passages of respect body portions of the first and second hinge portions.

15. The foldable light fixture of claim 14, wherein
each of the first and second hinge portions comprise a joint feature extending from the respective body portion of the first and second hinge portion and pivotally coupled with one another on a pivot axis, and
in the unfolded configuration, the electrical connector extends through the respective passages along the electrical connector pathway and substantially transverse to the pivot axis.

16. The foldable light fixture of claim 10, wherein
the main portion comprises a main portion light feature,
the wing portion comprises a wing portion light feature, and
the electrical connector is configured to support an electrical coupling of the main portion light feature and the wing portion light feature.

17. A hinge feature for a foldable light fixture, the hinge feature comprising:
a first hinge portion comprising
a first portion body defining a first passage, and
a first portion joint feature extending from the first portion body; and
a second hinge portion comprising
a second portion body defining a second passage, and
a second portion joint feature extending from the second portion body,
wherein the first portion joint feature and the second portion joint feature are pivotally coupled with one another on a pivot axis of the hinge feature,
wherein the first passage and the second passage cooperate to define an electrical connector pathway through the hinge feature that is configured to receive an electrical connector extending therethrough, and
wherein the hinge feature is configured to maintain the electrical connector in the electrical connector pathway during a pivoting movement of the first and second joint features about the pivoting axis.

18. The hinge feature of claim 17, wherein the first hinge portion comprises a set of tube mates protruding from the first portion body opposite the first portion joint feature and configured for engagement with a frame component of the light fixture.

19. The hinge feature of claim 17, wherein the first portion body defines a protruding ledge adjacent the first portion joint feature, the protruding ledge configured to define a landing for the second portion joint feature such that the second portion joint feature is pivotally coupleable with the first portion joint feature.

20. The hinge feature of claim 17, wherein the first portion body defines a face configured to establish a stop position for the second portion body about the pivot axis.
